(19) United States
(12) Patent Application Publication
(10) Pub. No.: US 2021/0285632 A1
(43) Pub. Date: Sep. 16, 2021

(54) ILLUMINATING A TEXTILE

(71) Applicant: OSRAM GMBH, München (DE)

(72) Inventor: Michael BOENIGK, Berlin (DE)

(21) Appl. No.: 17/197,958

(22) Filed: Mar. 10, 2021

(30) Foreign Application Priority Data
Mar. 10, 2020 (DE) 10 2020 203 041.3

(51) Int. Cl. F21V 33/00; F21V 23/06; F21L 4/02; H02J 7/00

(52) U.S. Cl. CPC F21V 33/0008; F21V 23/06; A41B 1/08; H02J 7/00308; F21L 4/022

(57) ABSTRACT

A lighting device for mechanical connection to a textile, comprising comprises an electrically operable illuminant, a light guiding element which, in terms of lighting engineering, is coupled to the at least one illuminant and is configured at least partly to receive, guide and emit the light emitted by the at least one illuminant, an at least three-pole electrical luminaire plug connector for electrical connection to an electrical battery appliance, wherein the luminaire plug connector is electrically connected to the at least one illuminant, wherein the illuminant and/or the light guiding element have/has a connection element for mechanical connection to the textile, a control voltage unit, which is electrically coupled to the luminaire plug connector for application of the electrical operating voltage and is configured to provide depending on the illuminant at the luminaire plug connector a control voltage for control of the operating voltage by of the battery appliance.

The invention relates to a lighting device for mechanical connection to a textile, in particular a garment, comprising at least one electrically operable illuminant which emits light upon an electrical operating voltage being applied to it, at least one light guiding element which, in terms of lighting engineering, is coupled to the at least one illuminant and is configured at least partly to receive, to guide and to emit the light emitted by the at least one illuminant, an at least three-pole electrical luminaire plug connector for electrical connection to an electrical battery appliance, which provides the electrical operating voltage, wherein the luminaire plug connector is electrically connected to the at least one illuminant in order to apply the electrical operating voltage of the battery appliance to the illuminant, wherein the at least one illuminant and/or the at least one light guiding element have/has at least one connection element for mechanical connection to the textile. The invention furthermore relates to a battery appliance for a lighting device, comprising at least one battery cell for reversible electrochemical storage of electrical energy, an energy converter connected to the at least one battery cell and serving for providing an operating voltage, and an at least three-pole electrical battery plug connector for electrical connection to the lighting device, wherein for providing the operating voltage for the lighting device the battery plug connector is electrically connected to the energy converter. Furthermore, the invention relates to a lighting system for mechanical connection to a textile, in particular a garment, comprising a lighting device for mechanical connection to the textile and comprising at least one electrically operable illuminant which emits light upon an electrical operating voltage being applied to it, at least one light guiding element which, in terms of lighting engineering, is coupled to the at least one illuminant and is configured at least partly to receive, to guide and to emit the light emitted by the at least one illuminant, an at least three-pole electrical luminaire plug connector for electrical connection to an electrical battery appliance, which provides the electrical operating voltage, wherein the luminaire plug connector is electrically connected to the at least one illuminant in order to apply the electrical operating voltage of the battery appliance to the illuminant, and wherein the at least one illuminant and/or the at least one light guiding element have/has at least one connection element for mechanical connection to the textile, and comprising a battery appliance for the lighting device, wherein the battery appliance comprises at least one battery cell for reversible electrochemical storage of electrical energy, an energy converter connected to the at least one battery cell and serving for providing the operating voltage, and an at least three-pole electrical battery plug connector for electrical connection to the lighting device, wherein for providing the operating voltage for the lighting device the battery plug connector is electrically connectable to the energy converter. Finally, the invention also relates to a textile, in particular a garment, comprising a lighting system.

Lighting devices, battery appliances for such lighting devices, lighting systems and textiles comprising lighting systems are known in the prior art. In this regard, WO 2019/072530 A1, for example, discloses a light module for textiles, in particular clothing, and textile or partially textile accessories and textiles comprising said light module. The use of textiles comprising lighting systems is finding ever greater application. Particularly in the field of health and safety at work, but also in the field of events, for example public performances or the like, and also in the private sphere, the use of textiles which emit light is widespread. In this regard, it is known, for example, to equip jackets, trousers or the like with retroreflective strips in order to ensure visibility for third parties not only during the day but in particular also in darkness, particularly at night. It is precisely in darkness when this type of visually perceptible protection necessitates illumination of the retroreflective strips with light from a light source, for example a headlight of a vehicle or the like, because their functionality is based on the reflection of light. WO 2019/072530 A1 therefore proposes a light module for textiles which, on the basis of light emitting diodes as illuminants, makes use of a light emission via a light emitting optical waveguide connected to the textile. A battery appliance is provided for operation of the light emitting diode, said battery appliance being able to be electrically coupled to the light module via a releasable plug connection on the basis of the USB standard.

Even though this teaching has basically turned out to be successful, it nevertheless proves to be problematic, however, if the textile is intended to be cleaned, for example the garment is intended to be washed. Washability of the light modules comprising the battery appliance is generally not provided. Furthermore, the teaching of WO 2019/072530 A1 proves to be unfavorable with regard to flexibility of use with different lighting devices. Although there is the possibility, if there are different lighting devices, of providing an additional energy converter, which can be used to realize a corresponding adaptation of the operating voltage or of the operating current, this design proves to be unfavorable with regard to efficiency, especially since the additional energy converter is generally to be configured as an in-phase regulator. However, as efficient energy utilization as possible is desired precisely in the case of mobile application. The unfavorable utilization of the electrical energy on account of the additional energy converter furthermore results in heating that may be undesirable, if not even dangerous, in the case of the intended use of the textile.

The invention addresses the problem of developing a lighting device of the generic type, a battery appliance of the generic type, a lighting system of the generic type and a textile of the generic type to the effect that the available electrical energy can be better utilized and/or greater flexibility can be achieved with regard to the design.

As a solution, the invention proposes a lighting device, a battery appliance, a lighting system and a textile as claimed in the independent claims.

Advantageous developments are afforded by features of the dependent claims.

With regard to a lighting device of the generic type, the invention proposes, in particular, that the lighting device comprises a control voltage unit, which is electrically coupled to the luminaire plug connector for application of the electrical operating voltage and is configured to provide depending on the at least one illuminant at the luminaire plug connector a control voltage for control of the operating voltage by means of the battery appliance.

With regard to a battery appliance of the generic type, the invention proposes, in particular, that said battery appliance comprises a setting unit electrically coupled to the energy converter and the battery plug connector and serving for controlling the energy converter, wherein the setting unit is configured to set the operating voltage depending on a control voltage of the lighting device detected at the battery plug connector.

With regard to a lighting system of the generic type, the invention proposes, in particular, that the lighting device and the battery appliance are configured according to the invention and the battery plug connector is releasably connectable to the luminaire plug connector.

With regard to a textile of the generic type, the invention proposes, in particular, that the textile comprises a lighting system according to the invention.

The invention is based on the concept, inter alia, that the lighting device can make available by providing the control voltage to the battery appliance information about the operating voltage required by the lighting device. The battery appliance is therefore configured to be able to set the operating voltage depending on the detected control voltage. The battery appliance realizes this by way of its energy converter, which can be set with regard to the operating voltage by means of the setting unit. As a result, it is possible to be able to realize operation of different combinations of battery appliances and lighting devices with one another. Furthermore, it is possible to avoid the need to provide an additional energy conversion if the battery appliance is operated with a lighting device for which the battery appliance was not originally designed. It is thereby possible to improve the flexibility with regard to the use of textile lighting devices. Furthermore, the utilization of the electrical energy of the battery appliance can likewise be improved because additional energy conversions can be obviated.

This furthermore allows the battery appliance and the lighting device to be able to be designed and fabricated independently of one another within wide limits. The battery appliance, particularly if it comprises a battery plug connector in accordance with the USB standard, can be used as a USB power bank, such as is used for supplying energy to commercially available USB appliances, for example for charging the latter. The invention allows this functionality furthermore to be able to be provided with the battery appliance according to the invention, such that for example this basic function or this area of use of a USB power bank continues to be available. The invention can even be retrofitted in battery appliances of the generic type. The invention thus allows the USB power bank also to be extended for use with a textile light module, without the generic use having to be restricted. That is to say that if no electrical voltage is present at the corresponding terminal of the battery plug connector, the battery appliance can preferably still be used like a USB power bank.

Textiles are materials which are processed from textile or non-textile starting materials by means of suitable working processes to form linear, sheetlike or three-dimensional structures. Sheetlike textiles are formed for example by wovens, formed-loop knits, drawn-loop knits, braids, stitchbondeds, web materials and also felts or the like. Textiles are used, in particular, in order to be able to produce garments. A garment is a material which at least partly surrounds a person's body in the manner of an artificial covering and generally remains fitted to the body during intended use.

In order that the textile or the garment can be visually perceived better, for example, in particular in darkness, it comprises the lighting device, which is mechanically connected to the textile. However, the invention is not limited to the application for improving safety, but rather can also be used for other applications, in which for example signaling is desired, or the like.

The connection of at least the lighting device to the textile can be configured as releasable, but it is preferably configured as non-releasable. For this purpose, the at least one illuminant and/or the at least one light guiding element can have at least one connection element for mechanical connection to the textile. The connection element can be formed for example by a strap, a thin, planar, flat layer, or the like, which is connected to the textile by means of a connection method. The connection can be realized for example by means of adhesive bonding, stitching, welding and/or the like. Furthermore, releasable connection elements can also be provided, of course, for example buttons, in particular press studs, zippers, combinations thereof and/or the like.

The electrically operable illuminant preferably comprises one or more light emitting diodes. However, it can basically also comprise one or more incandescent lamps, one or more glow lamps, combinations thereof and/or the like. The electrically operable illuminant has at least two electrical terminals at which the electrical operating voltage can be applied to it. Depending on application of the electrical operating voltage, the illuminant then emits the light.

The lighting device furthermore comprises at least one light guiding element which, in terms of lighting engineering, is coupled to the at least one illuminant. For this purpose, the light guiding element can have a light receiving region facing the illuminant. The illuminant can be arranged opposite the light receiving region in a suitable manner.

The light guiding element is configured at least partly to receive, to guide and to emit the light emitted by the at least one illuminant. What can thereby be achieved, inter alia, is that the light, particularly in the case of an almost punctiform illuminant such as the light emitting diode, is coupled into the light guiding element via a light receiving region of the light guiding element, for example, and is coupled out of the light guiding element and emitted at predefinable locations. The light guiding element thus serves to guide the received light at least partly to the locations of light emission or emission of the light through the light guiding element.

The light guiding element can be formed for example from a suitably configured plastic or else a composite material, or the like, which is configured as at least opaque, but preferably as at least partly transparent. For the purpose of emitting the light, the light guiding element can have optically active elements that deflect part of the luminous flux, such that the light can be emitted by the light guiding element. As a result, strip-shaped light guiding elements can be formed, for example, which are able to emit light at least over part of their outer surface, preferably over their entire outer surface. However, the light guiding element need not be configured as a strip. It can also have virtually any other contour, for example circular, angular, combinations thereof, and/or the like.

Furthermore, provision can be made for the light guiding element to emit the light only at surfaces arranged facing away from a textile surface. What can thereby be achieved is that the light emission is effected in the spatial region in which visual perception by third parties or optical sensors is made possible. Furthermore, the light guiding element need not emit the light uniformly over its surface. In this regard, the light can also be emitted nonuniformly, for example, in order to represent visual patterns.

The light guiding element can be embodied in an integral fashion. Furthermore, the light guiding element can, of course, also be embodied in a multipartite fashion, wherein the parts can be optically coupled to one another. This allows rigid light guiding elements, such as, for example, glass or the like, also to be used with the textile. The light guiding element can also be embodied at least partly in one piece with the at least one illuminant. The light guiding element is embodied at least in a flexurally stiff fashion, such that it can at least partly follow changes in shape of the textile during intended use. This is advantageous in particular for textiles that are worn by persons. The flexibility allows the textile to be able to be used substantially like normal clothing. The light guiding element is therefore embodied preferably in a flexible fashion, particularly preferably in an elastic fashion. If the light guiding element is embodied in a multipartite fashion, the flexibility or the elasticity can be provided by suitable connection means. Said connection means can comprise for example joints or the like.

The light guiding element is preferably embodied at least partly as a flat, planar element having a small height in relation to a longitudinal and/or transverse extent corresponding preferably to a surface of the textile.

The luminaire plug connector serving for electrical connection to the electrical battery appliance is configured with at least three poles. Two of the three poles of the luminaire plug connector serve for providing the electrical operating voltage. Therefore, the illuminant is preferably also connected to these poles of the luminaire plug connector. The illuminant can preferably be directly connected to said poles. Furthermore, however, further means can also be interposed, for example one or more electrical resistors or the like.

The third pole of the luminaire plug connector can be used for being electrically coupled to the control voltage unit, such that the control voltage can be provided at the third pole of the luminaire plug connector. As a result, both the operating voltage and the control voltage can be transmitted by a single plug connection. Depending on requirements, the luminaire plug connector can, of course, also have more than three poles, particularly if more than a single operating voltage is intended to be provided. Furthermore, in such a case, provision can also be made, of course, for respective individually assigned control voltages to be provided by the control voltage unit for each of the operating voltages. The control voltage unit is then preferably connected to each of the operating voltages.

The control voltage unit is configured to provide the control voltage depending on the illuminant. For this purpose, provision can be made for the control voltage unit already to be correspondingly designed or programmed during the production of the lighting device in order that the desired control voltage is provided. Preferably, the control voltage unit can be configured in such a way that it also provides the control voltage depending on the detected operating voltage. At the same time, providing the control voltage can also be set depending on the at least one illuminant of the lighting device. In this regard, for example, the control voltage unit can be configured to provide the control voltage according to a predefined number of series-connected light emitting diodes as illuminants.

Preferably, the luminaire plug connector is configured in accordance with a USB standard. USB (universal serial bus) is a serial standardized bus system which, inter alia, can also serve for communication-technological or electrical connection of a computer to an external appliance. In the case of said standard, the terminals or poles V_{Bus} and GND can be used for providing the operating voltage. The poles or terminals D+ and D− can be electrically connected to one another and used for providing the control voltage. As a result, it is possible, in a simple manner, for a plug connector that is already used in many instances to be used for the realization of the invention. Costs and development expenditure can be saved as a result. Furthermore, this configuration allows the invention to be implemented in already existing designs with little expenditure, without hampering the standard use. As a result, the diversity can be improved overall.

In accordance with one development, it is proposed that for providing the control voltage the control voltage unit has at least one electrical resistor which is electrically connected by one of its terminals to one of two electrical potentials of the electrical operating voltage. In this way, a corresponding control voltage can be provided in a particularly simple manner. An electrical resistance value of the electrical resistor can be chosen depending on the illuminant, such that on the battery appliance side by way of a predefined loading at the second terminal of the electrical resistor, the corresponding electrical control voltage can be provided and detected. It is thereby possible, in a particularly simple manner, to provide the control voltage by means of the control voltage unit. The electrical potentials of the electrical operating voltage are available at the corresponding poles of the luminaire plug connector. In this case, the control voltage unit needs to be electrically connected only to one of these poles of the luminaire plug connector.

Basically, however, provision can also be made for the control voltage to be provided by a voltage divider formed from at least two electrical resistors, which is connected to the operating voltage. In this case, the control voltage unit is preferably to be supplied with the operating voltage, of course. The voltage divider can be fabricated depending on the type of illuminant. Furthermore, the control voltage unit can also comprise further electronic elements, for example at least one electrical capacitor or the like, in order to be able to provide the desired control voltage.

It is furthermore proposed that for providing the control voltage the control voltage unit comprises at least one computer unit. The computer unit can be configured to generate the control voltage from a digital value stored in the control voltage unit, for example by carrying out a corresponding data processing, in particular a digital-to-analog conversion. The digital value can be chosen depending on the at least one illuminant and can be stored in a corresponding storage unit in a readable manner during the production of the lighting device, for example. The digital value can then be read from said storage unit and, as explained above, be processed. This allows the control voltage to be provided in a simple and highly flexible manner.

Furthermore, it is proposed that the control voltage unit is configured to identify the at least one illuminant of the lighting device and to provide the corresponding suitable control voltage depending on that. This configuration has the advantage that the control voltage can be provided in an automated manner, specifically preferably during intended operation of the lighting device. There is therefore no need to provide separate setting measures during the production of the lighting device.

In accordance with one development, it is proposed that the control voltage unit has an energy storage cell for storing electrical energy. As a result, the control voltage unit can already provide the control voltage even if an operating voltage is not yet available. This has the advantage that during connection of the plug connectors of the lighting device and of the battery appliance, the battery appliance already acquires corresponding voltage information, such that the operating voltage can be correspondingly set already during production of the connection. This has the advantage that an overloading of the illuminant on account of an operating voltage not yet having been adapted during production of the electrical connection can be avoided. The reliability can be increased as a result.

It is furthermore proposed that the lighting device comprises an overvoltage protection unit. What can be achieved by means of the overvoltage protection unit is that the illuminant can be protected against an unadapted operating voltage during production of the plug connection. The overvoltage protection unit can be formed for example by one or more Zener diodes, a varistor, a suppressor diode and/or the like. In the present case, the overvoltage protection unit is preferably configured in a manner adapted to the illuminant, such that the corresponding overvoltage protection can be achieved. This is advantageous in particular for the case where the lighting device is electrically coupled to a battery appliance which does not have a control functionality according to the invention and provides an operating voltage that is greater than a rated voltage of the illuminant. As a result, it is possible here, too, to avoid damage to the lighting device, in particular the illuminant.

The invention also encompasses the battery appliance for the lighting device according to the invention. The battery appliance preferably comprises at least one battery cell for reversible electrochemical storage of electrical energy. In general, however, the battery appliance comprises a plurality of corresponding battery cells, which can be connected in a series circuit and/or a parallel circuit as required. The battery cell can be for example a lithium-ion cell, a nickel-metal hydride cell and/or the like.

The battery appliance furthermore comprises the energy converter, by means of which the operating voltage can be provided. For this purpose, the energy converter is connected to the at least one battery cell. The energy converter can preferably be configured as a DC-DC converter, but can as required also be configured as an inverter or the like. The energy converter is connected to the at least three-pole electrical battery plug connector, specifically at least to two poles of the battery plug connector, in order that the electrical operating voltage can be provided at the corresponding poles of the battery plug connector. The battery plug connector serves for electrical connection to the lighting device, for which purpose it is preferably configured in a complementary fashion to the luminaire plug connector, such that the battery plug connector can be releasably connected to the luminaire plug connector in order to produce an electrical connection. Via the third pole of the battery plug connector, the battery appliance can then obtain from the lighting device the control voltage that can be used for setting the electrical operating voltage.

The setting unit serves for setting the operating voltage depending on the control voltage detected at the battery plug connector. The setting unit is preferably an electronic assembly that serves to control the energy converter in a suitable manner, such that the latter is able to provide the electrical operating voltage in a desired manner. Reference is made to the explanations above. The setting unit can be comprised by the energy converter. However, it can also be configured as a separate unit.

The battery plug connector, too, can be configured in accordance with the USB standard. In this regard, reference is made to the corresponding explanations above concerning the luminaire plug connector.

In accordance with one development, it is proposed that the setting unit comprises a regulator unit for regulating the operating voltage depending on the control voltage. By way of example, provision can be made for the regulator unit to serve for regulating the electrical operating voltage and therefore to detect as an input variable the electrical operating voltage provided at the battery plug connector as an actual value. Furthermore, the detected control voltage can be used as a setpoint value. This allows a reliable setting, in particular regulation, of the operating voltage to be able to be achieved.

Furthermore, there is also the possibility, of course, of using the control voltage to realize the regulation function and of providing the control voltage depending on an operating voltage detected at the luminaire plug connector. As a result, the plug connection overall can be included in the regulation. This has the advantage that for example a voltage drop on account of a contact resistance at the plug connection between the battery plug connector and the luminaire plug connector can be taken into account in the regulation. The reliability of the regulation and the accuracy of the regulation can be improved as a result. The control voltage can furthermore be used to reduce or to dim the operating voltage. As a result, a luminance of the at least one illuminant can be set. In this regard, provision can be made, for example, for enabling manual setting to a desired magnitude. Furthermore, provision can be made for enabling the control voltage supplementarily also to be predefined depending on a sensor signal, for example an ambient light intensity detected by means of a light sensor, a temperature detected by means of a temperature sensor, and/or the like. For example, an ambient temperature, a textile temperature, a temperature in the region of the at least one illuminant and/or the like can be detected by means of the temperature sensor.

It is furthermore proposed that the setting unit is configured to detect a state of charge of the at least one battery cell and to set the operating voltage depending on the detected state of charge. What can be achieved as a result is that information dependent on the state of charge of the battery appliance can already be output visually. By way of example, provision can be made for the operating voltage to be reduced step by step or continuously depending on the state of charge, in order for example to be able to lengthen intended operation as much as possible until the next process of charging the battery appliance. By reducing the operating voltage, it is also possible to reduce the emission of light by the illuminant of the lighting device, such that the user of the textile is given visually detectable feedback that the battery appliance should be caused to undergo a charging process as soon as possible.

Preferably, the battery appliance can comprise at least one connection element for releasable mechanical connection to the textile. As a result, the battery appliance—just like the lighting device—can be fixedly connected to the textile. With regard to the battery appliance, however, a releasable mechanical connection is advantageous in order that the battery appliance can be exchanged during the use of the textile if required by the state of charge, for example. This makes it possible to ensure further use of the lighting device after the change. The mechanical connection can be formed for example by buttons, press studs, a zipper, a hook and loop fastener and/or the like.

The battery appliance preferably comprises an at least partly flexibly configured housing. The flexibly configured housing enables the battery appliance to be at least partly adapted to different contours of the textile during intended use. This fosters in particular the usability of the textile as a garment. At the same time, the battery appliance is preferably configured as flat, such that its extent transversely with respect to the surface of the textile is small in comparison with the other two spatial directions. This has the advantage that if the textile is used as a garment, it impedes the movement of the user as little as possible. The same also applies, moreover, to the lighting device.

The lighting system comprises the lighting device according to the invention and also the battery appliance according to the invention. The battery plug connector is releasably connectable to the luminaire plug connector, such that the battery appliance can be removed from the textile in a simple manner for example during cleaning of the textile, such as washing or the like. This need not be provided for the lighting device, particularly if it is configured as suitable for the cleaning process. The lighting device can therefore also be connected to the textile in a non-releasable manner. Preferably, therefore, the lighting device is at least partly fixedly connected to the textile.

In accordance with one development, it is proposed that the battery appliance and/or the textile comprise(s) a connection element for releasable connection of the battery appliance to the textile. Here the same advantages and effects are applicable such as have already been explained above with regard to the lighting device and the battery appliance.

The advantages and effects indicated for the lighting device according to the invention and the advantages and effects indicated for the battery appliance according to the invention are, of course, also equally applicable to the lighting system according to the invention and the textile according to the invention, and vice versa.

The invention will be explained further below on the basis of exemplary embodiments. The exemplary embodiments explained below are preferred embodiments of the invention. The features and feature combinations indicated above in the description and also the features and feature combinations mentioned in the following description of exemplary embodiments and/or shown solely in the figures are usable not only in the combination respectively indicated, but also in other combinations. Consequently, embodiments which are not explicitly shown and explained in the figures, but emerge and are producible by way of separate feature combinations from the embodiments explained, are also encompassed by the invention or should be regarded as disclosed. The features, functions and/or effects presented on the basis of the exemplary embodiments can constitute by themselves in each case individual features, functions and/or effects of the invention which are to be considered independently of one another and which in each case also develop the invention independently of one another. Therefore, the exemplary embodiments are intended also to encompass combinations other than those in the embodiments explained. Furthermore, the embodiments described can also be supplemented by further features, functions and/or effects of the invention from among those already described.

In the figures, identical reference signs designate identical features and functions.

In the figures:

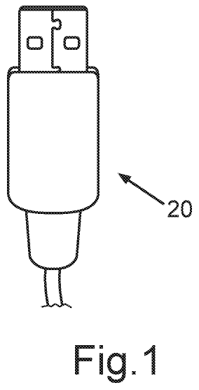

FIG. 1 shows a schematic plan view of a luminaire plug connector of a lighting device in accordance with a USB standard;

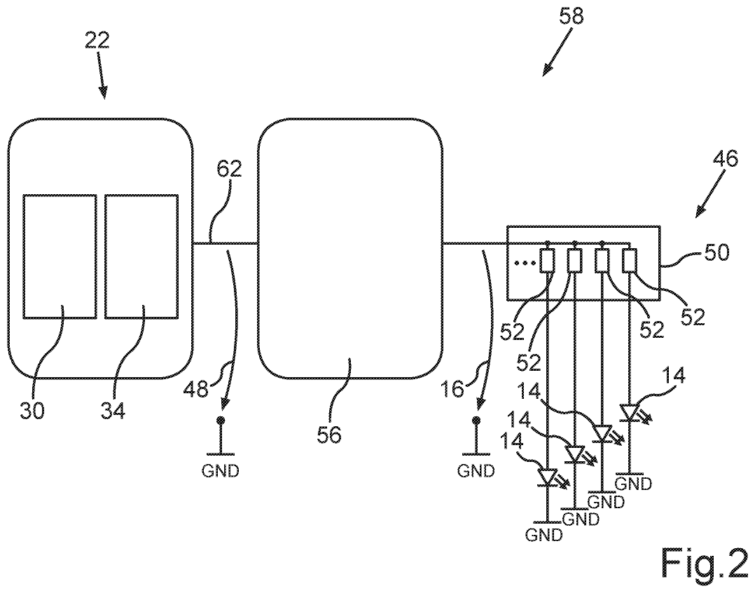

FIG. 2 shows a schematic block circuit diagram illustration of a lighting system with a lighting device comprising four light emitting diodes and an in-phase regulator, and also a battery appliance;

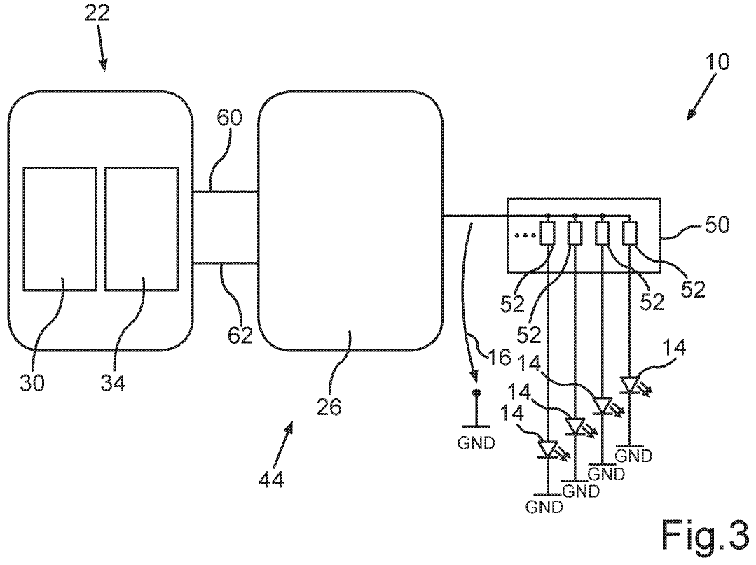

FIG. 3 shows a schematic block circuit diagram illustration like FIG. 2, but without an in-phase regulator;

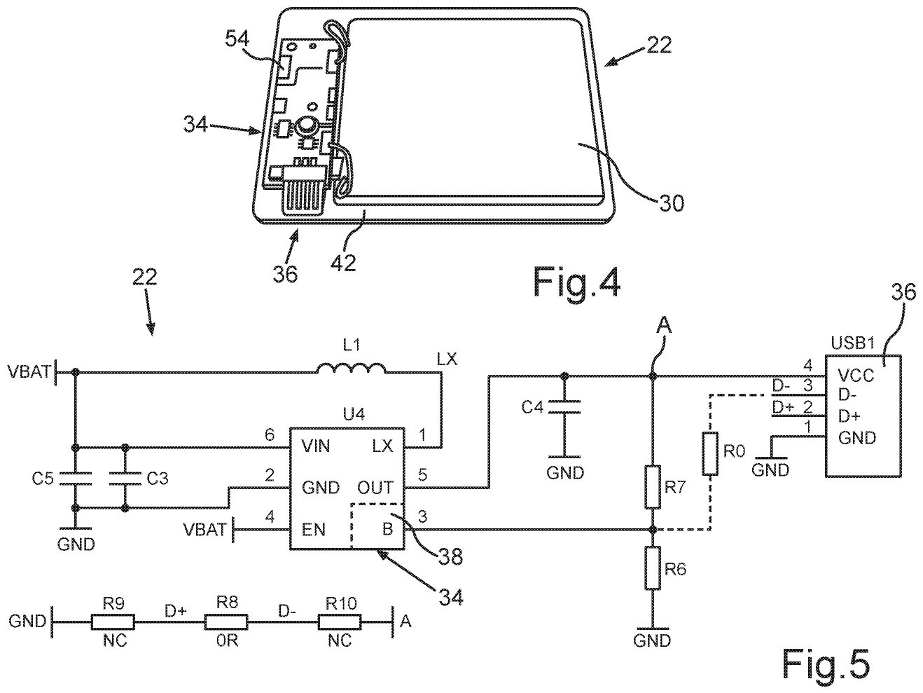

FIG. 4 shows a schematic view of a battery appliance arranged in half of a housing;

FIG. 5 shows a schematic circuit diagram illustration of a circuit of the battery appliance in accordance with FIG. 4 in the region of a DC/DC converter;

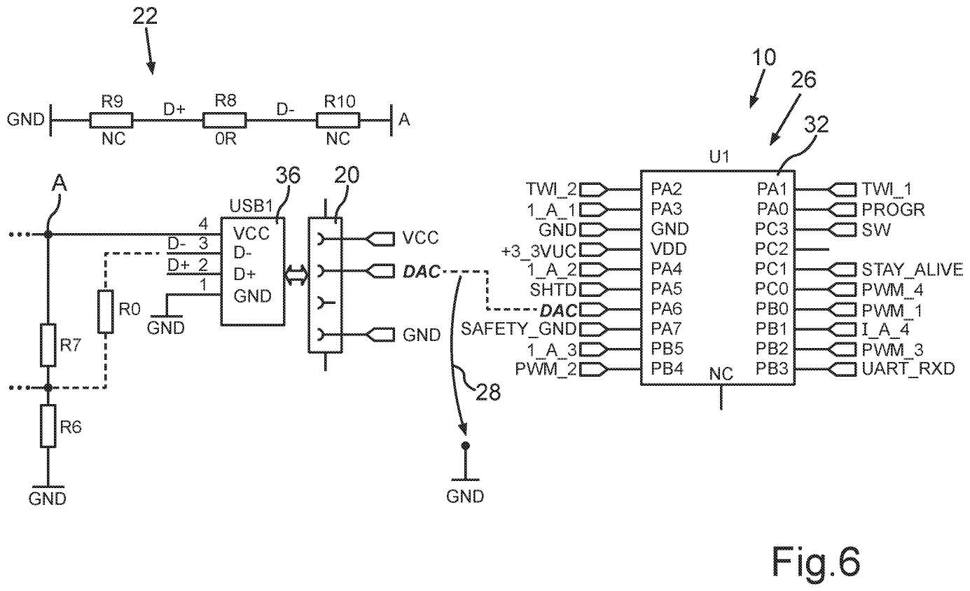

FIG. 6 shows a schematic reduced circuit diagram illustration of a lighting system in accordance with FIG. 3;

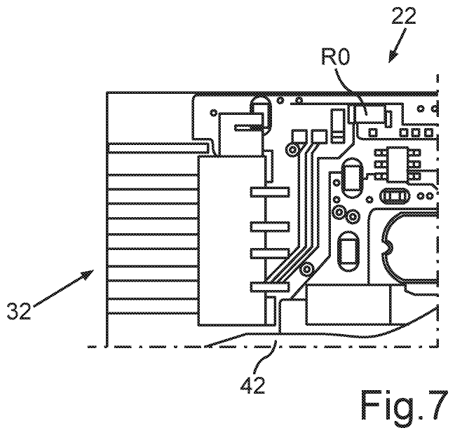

FIG. 7 shows a schematic plan view of a segment of the circuit of the battery appliance in accordance with FIG. 4 in the region of a battery plug connector;

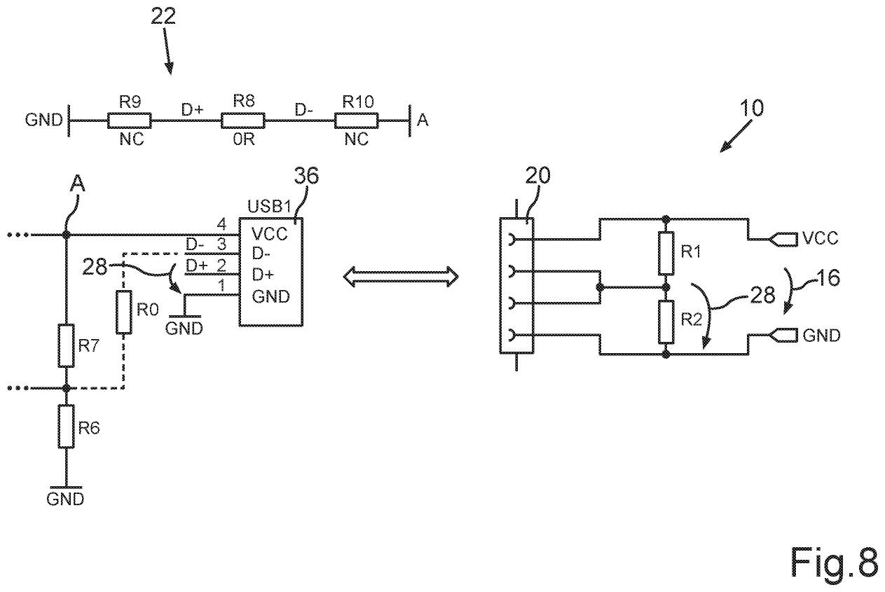

FIG. 8 shows a schematic circuit diagram illustration of a further lighting system like FIG. 6 in an alternative configuration;

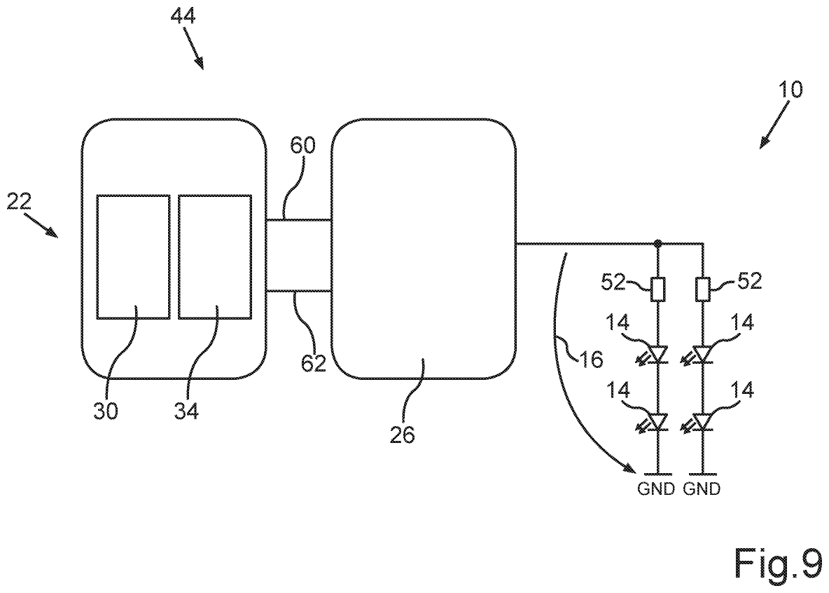

FIG. 9 shows a schematic block circuit diagram illustration like FIG. 3, but with series-connected light emitting diodes;

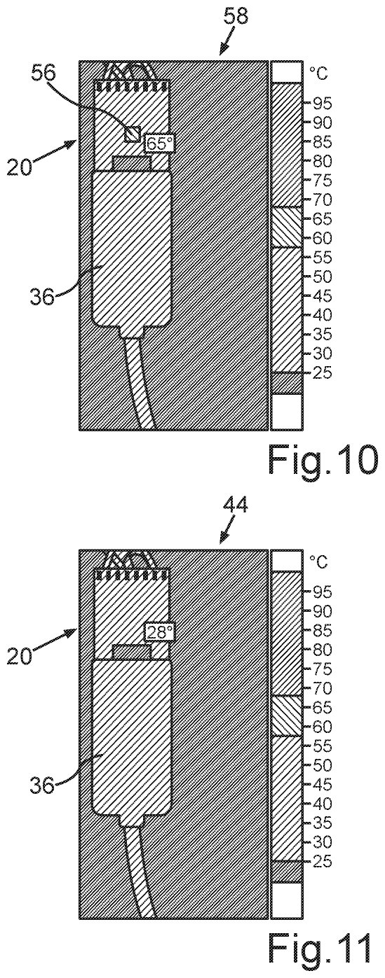

FIG. 10 shows a schematic thermographic illustration of a segment of the lighting system in accordance with FIG. 2 in the region of the plug connection;

FIG. 11 shows a schematic thermographic illustration like FIG. 10 for the lighting system in accordance with FIG. 3; and

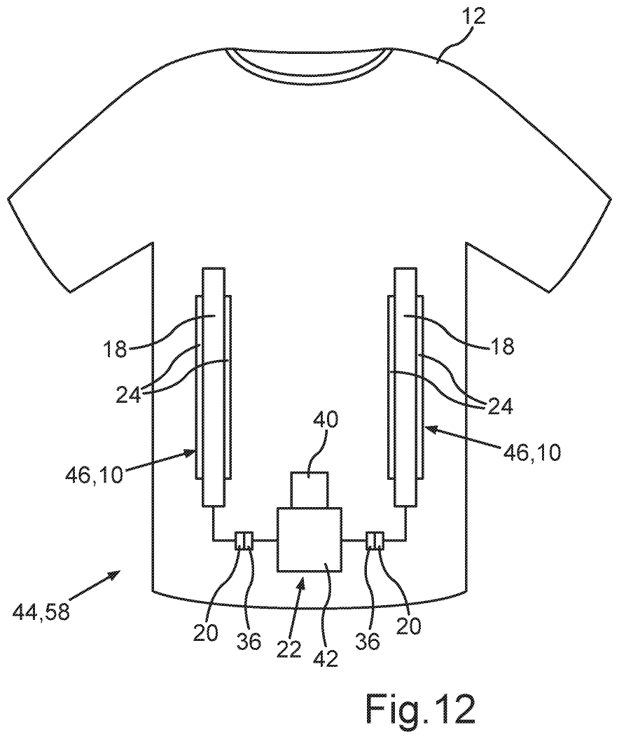

FIG. 12 shows a schematic illustration of a garment with a lighting system comprising two lighting devices.

FIG. 2 shows, in a schematic block circuit diagram illustration, a lighting system 58 comprising a battery appliance 22 comprising a plurality of parallel-connected lithium-ion cells as battery cells 30. The battery appliance 22 furthermore comprises a DC/DC converter 34, which converts a battery cell voltage VBat provided by the battery cells 30, which is approximately 3.7 V in the present case, into a battery appliance voltage 48 of approximately 5 V in the present case. The battery appliance 22 thus provides a substantially constant DC voltage of approximately 5 V. During intended operation of the battery appliance 22, the DC/DC converter 34 ensures that the battery appliance voltage 48 remains substantially constant, unless operating conditions of the battery cells 30 prevent this, for example on account of the state of charge, the temperature and/or the like. The battery appliance 22 provides the battery appliance voltage 48 at a battery plug connector 36. This is illustrated by way of example with reference to FIGS. 4 to 8 and 12.

FIG. 12 shows a garment 12 as textile, comprising a lighting system 44 or 58. This will be explained in even greater detail below. The garment 12 is produced from cotton, for example, in the present case. However, it can basically also be produced from some other suitable material.

The lighting system 58 is shown in FIG. 2. It is evident from FIG. 2 that a lighting device 46 is connected to the battery appliance 22. The lighting system 58 is configured for mechanical connection to the garment 12. Besides the battery appliance 22, the lighting system 58 comprises the lighting device 46, which is evident from FIG. 12. In the present case, the lighting device 46 comprises securing straps 24 configured as connection elements for mechanical connection to the garment 12. The securing straps 24 are fixedly connected to the garment 12 by means of adhesive bonding technology in the present case.

In the present configuration, the lighting device 46 comprises four light emitting diodes 14, which emit light upon application of an electrical operating voltage 16. It is evident from FIG. 2 that the operating voltage 16 is applied to respective series resistors 52 of the light emitting diodes 14 in order that it is possible to achieve a balancing of the electrical application undergone by the light emitting diodes 14, in particular also with regard to a loading with an electric current. The series resistors 52 can also serve to limit the electric current through the respective light emitting diodes 14. For this purpose, a splitter 50 is provided, to which the operating voltage 16 is applied and which contains series resistors 52.

It is evident from FIG. 12 that the lighting device 46 comprises a light guiding element 18, which, in terms of lighting engineering, is coupled to the light emitting diodes 14 and is configured to receive, to guide and to emit the light emitted by the light emitting diodes 14. In the present case, the light guiding element 18 is formed by a flexible part made of plastic and having a suitable transparency for guiding the light. Furthermore, provision is made for the light guiding element 18 to comprise output coupling elements for coupling out the guided light, such that the light can be emitted toward the outside over the extent of the illuminant. In the present case, the output coupling elements are embodied on a surface opposite the surface of the light guiding element 18 that faces the garment 12. However, this is not shown in the figures.

The lighting device 46 furthermore comprises a luminaire plug connector 20 (FIGS. 6, 8, 12), which, during intended operation, is mechanically connected to the battery plug connector 36 and produces an electrical coupling in this way. The battery appliance voltage 48 can thus be fed to the lighting device 46 via the luminaire plug connector 20.

In the case illustrated in FIG. 2, the operating voltage 16, which is approximately 3.5 V in the present case, is significantly less than the battery appliance voltage 48, which is approximately 5 V in the present case. For this reason, the lighting device 46 also comprises an in-phase regulator 56, which is likewise arranged in the luminaire plug connector 20 in the present case. The function of the in-phase regulator 56 is sufficiently known to the person skilled in the art, and so a detailed explanation of this function is not required. The in-phase regulator 56 is generally formed by an analog electronic circuit that regulates a DC input voltage to a lower DC output voltage. As a result, it is possible to achieve a voltage adaptation for the intended operation of the lighting device 46.

FIG. 1 shows the luminaire plug connector 20 such as is used by the lighting device 46. In this configuration, the luminaire plug connector 20 comprises a housing, in which the in-phase regulator 56 and the splitter 50 are also arranged. The luminaire plug connector 20 is therefore subjected to high thermal loading.

Even though this principle has basically turned out to be successful, the lighting system 58 nevertheless proves to be disadvantageous, however, with regard to some aspects. In particular, it is found to be disadvantageous that during intended operation the in-phase regulator 56 not only adversely affects the total efficiency but also provides for an undesired level of heating. Furthermore, the design of the lighting device 46 proves to be disadvantageous in as much as it has to be designed in a manner individually adapted to the respective number of light emitting diodes.

FIG. 3 then shows, in a schematic block circuit diagram illustration like FIG. 2, how the problems mentioned above can be reduced, if not even completely avoided. For this purpose, it is provided that—in contrast to the lighting system 58 in accordance with FIG. 2—the battery appliance 22 is coupled to the lighting device 46 not just via supply lines 62, via which the battery appliance voltage 48 can be provided to the lighting device 46, rather a control line 60 is additionally provided. FIG. 3 therefore shows a lighting system 44, the differences of which with respect to the lighting system 58 are explained below.

Accordingly, a lighting device 10 is provided in the lighting system 44, this lighting device differing from the lighting device 46 of the lighting system 58. Only the differences will be discussed below. The use of the light emitting diodes 14 as illuminants and also of the splitter 50 corresponds to what has already been explained above with regard to the lighting device 46, for which reason reference is supplementarily made to the explanations in regard thereof.

In contrast to the lighting device 46, the lighting device 10 comprises a control voltage unit 26 instead of the in-phase regulator 56, said control voltage unit being connected to the luminaire plug connector 20 for application of the electrical operating voltage 16. The control voltage unit 26 is configured to provide depending on the illuminant, which here is formed by the four light emitting diodes 14, at the luminaire plug connector 20 a control voltage 28 for control of the operating voltage 16 by means of the battery appliance 22. Said control voltage 28 is transmitted to the battery appliance 22 via the control line 60. As will be explained even further below, the control voltage 28 (FIGS. 6, 8) is fed to the DC/DC converter 34 of the battery appliance 22, such that the battery appliance voltage 48 can be set to the operating voltage 16.

The control voltage 28 can be formed by a fixed voltage value that can be provided by the control voltage unit 26. For this purpose, the control voltage unit 26 can already be correspondingly designed and/or programmed during the production of the lighting device 10.

In one configuration, the control voltage unit 26 can be formed by a voltage divider comprising two electrical resistors R1, R2 connected in series, as is illustrated with reference to FIG. 8. The control voltage 28 can then be passed to the luminaire plug connector 20, which is configured according to the USB standard in the present case. For this purpose, this configuration provides for the corresponding terminals of the luminaire plug connector 20, namely the terminals D+ and D− to be electrically connected to one another and for the control voltage 28 to be applied to these terminals. These two terminals D+ and D− are generally not used for a pure energy supply function by the battery appliance 22, or, according to the USB charging standard, are electrically connected to one another only within the battery appliance and can accordingly be used for the transmission of the control voltage 28.

In order that the battery appliance 22 can set the battery appliance voltage 48 to the operating voltage 16, it is necessary to equip the battery appliance 22 in accordance with FIG. 8 with an additional electrical resistor R0, as is illustrated with reference to FIGS. 5 and 8. FIG. 5 shows, in a schematic circuit diagram illustration, a segment of the circuit of the battery appliance 22 in the region of the DC/DC converter 34. It can be discerned that the DC/DC converter 34 comprises a setting unit 38, the input terminal of which is connected to a center tap of a voltage divider comprising two electrical resistors R6, R7. The series circuit is connected to the battery appliance voltage 48 and ensures that in standard operation without the control voltage 28, the battery appliance voltage 48 is regulated to approximately 5 V.

Furthermore, one terminal of the electrical resistor R0 is connected to the center tap. By contrast, another terminal of the electrical resistor R0 is connected to the terminal D− of the battery plug connector 36. As a result, the control voltage 28 made available in the state connected to the luminaire plug connector 20 can additionally act on the center tap, as a result of which the battery appliance voltage 48 can be influenced on account of the regulation. What can be achieved by a suitable choice of the values of the resistors is that the battery appliance voltage 48 corresponds to the operating voltage 16. Therefore, the in-phase regulator 56 of the lighting device 46 can be avoided in the lighting device 10. The operating voltage 16 is thus available directly at the luminaire plug connector 20, as a result of which it is possible not only to save expenditure for the voltage regulation but also to increase the efficiency.

FIG. 4 shows an internal construction of the battery appliance 22 in a schematic plan view. It can be discerned that the battery cells 30 are connected to a printed circuit board (not designated) comprising the DC/DC converter 34. Furthermore, the printed circuit board also comprises a charging unit 54, which serves to be able to electrically charge the battery cells 30 as required. Finally, the printed circuit board also comprises the battery plug connector 36, which is configured according to the USB standard in the present case.

FIG. 6 shows an alternative configuration of the control voltage unit 26 vis-à-vis FIG. 8. Instead of the voltage divider formed by the electrical resistors R1, R2, a microprocessor 32 is provided in the case of the control voltage unit 26 in accordance with FIG. 6, said microprocessor providing the control voltage 28 at an output terminal. This output terminal comprises a digital-to-analog converter, such that the value for the control voltage can be read from a digital storage facility (not illustrated) and be provided at the corresponding terminal of the microprocessor 32. As a result, the value for the control voltage 28 can be stored in the corresponding storage unit during the production of the lighting device 10, with the result that the construction of the lighting device 10 need not be changed if the operating voltage 16 varies depending on the lighting device 10 being equipped with corresponding illuminants. This is particularly advantageous in terms of production engineering.

Furthermore, provision can also be made, of course, for the microprocessor 32 to perform a monitoring function, for example to monitor the function of the light emitting diodes 14 and optionally to correspondingly adapt the control voltage 28 in the event of failure of one of the light emitting diodes 14. Further additional functions can also be provided if necessary.

FIG. 7 shows a segment of the printed circuit board in accordance with FIG. 4 in plan view in the region of the battery plug connector 36. It can be discerned that the resistor R0 is mounted here. In this configuration, the resistor R0 has an electrical resistance value of approximately 1 MΩ.

FIG. 9 shows, in a schematic block circuit diagram illustration like FIG. 3, a configuration in which in each case two light emitting diodes 14 are connected in series. This configuration requires, of course, a different operating voltage 16 than that required for the configuration in accordance with FIG. 3. Therefore, the control voltage unit 26 provides a correspondingly adapted control voltage 28, such that the battery appliance 22, in particular the DC/DC converter 34, provides a correspondingly higher operating voltage 16, which is approximately 5.25 V in the case of this configuration. Only two light emitting diode branches are present in this configuration compared with the configuration in accordance with FIG. 3. Therefore, the splitter 50 can also be obviated.

FIG. 12 shows, in a schematic illustration, the lighting system 44 arranged on a garment 12. The lighting system 44 in the present case, just like the lighting system 58, comprises two lighting devices 10, which are supplied with electrical energy from the battery appliance 22 via respective plug connections 20, 36. For this purpose, in this configuration the battery appliance 22 comprises two battery plug connectors 36. The latter are connected in parallel on the battery appliance side in the present case. Depending on the application, however, provision can also be made for the battery plug connectors 36 to be electrically coupled to respective individual DC/DC converters 34, such that operating voltages 16 for the lighting devices 10 can be provided independently of one another. This also allows the lighting devices 10 not to have to be configured identically.

It can furthermore be discerned that the lighting devices 10 and also the battery appliance 22 have connecting straps 24 and 40, respectively, by which they are secured to the garment 12. In the present configuration, provision is made for the securing straps 24 to be adhesively bonded to the garment 12. In alternative configurations, provision can also be made here for the securing straps 24 to be stitched. In the present case, the connecting strap 40 of the battery appliance 22 is releasably connected to the garment 12 by means of a button connection. This allows the battery appliance 22 to be exchanged if a state of charge of the battery cells 30 no longer allows intended operation of the lighting devices 10.

It is furthermore evident from FIG. 12 that the battery appliance 22 comprises a housing 42 (also cf. FIG. 4). In the present case, the housing 42 is formed from a flexible plastic and accommodates all the components of the battery appliance 22. In the present case, provision is furthermore made for the battery appliance 22 to be configured as flat, such that it projects as little as possible in the state connected to the garment 12. What can be achieved as a result is that the battery appliance 22 impedes as little as possible a person wearing the garment 12 during intended operation.

The advantageous effect of the invention is furthermore evident from the schematic thermographic illustrations with reference to FIGS. 10 and 11. FIG. 10 shows a schematic thermographic illustration in which the luminaire plug connector 20 is mechanically coupled to the battery plug connector 36. The lighting system 58 in accordance with FIG. 2 is involved here. Furthermore, the in-phase regulator 56 is arranged in a housing (not designated) of the luminaire plug connector 20. It is evident from FIG. 10 that in the region of the in-phase regulator 56 an elevated temperature arises during intended operation, which in the present case is approximately 65° C. This can have the effect that the garment 12 is subjected to severe thermal loading and undergoes increased aging. Furthermore, there is the risk of injury for a person wearing this garment.

FIG. 11 shows, in a schematic thermographic illustration like FIG. 10, the same conditions for the plug connection in the case of the lighting system 44. It can be discerned that the plug connection is at approximately 28° C. at its hottest location. This is a significant temperature reduction indicating that the efficiency of the lighting system 44 is also significantly greater than the efficiency of the lighting system 58. As a result, for a predefined electrical capacity of the battery appliance 22, a significantly longer period of operation until exchange of the battery appliance 22 can be achieved with the lighting system 44 by comparison with the lighting system 58.

The exemplary embodiments serve exclusively for explanation of the invention and are not intended to restrict the latter.

### LIST OF REFERENCE SIGNS

10 Lighting device
12 Garment
14 Light emitting diode
16 Operating voltage
18 Transparent strip of plastic
20 Luminaire plug connector
22 Battery appliance
24 Securing strap
26 Control voltage unit
28 Control voltage
30 Battery cell
32 Microprocessor
34 DC/DC converter
36 Battery plug connector
38 Setting unit
40 Connecting strap
42 Housing
44 Lighting system
46 Lighting device
48 Battery appliance voltage
50 Splitter
52 Series resistor
54 Charging unit
56 In-phase regulator
58 Lighting system
60 Control line
62 Supply lines
GND Electrical reference potential
R0 Resistor
R1 Resistor
R2 Resistor
R6 Resistor
R7 Resistor
VBat Battery cell voltage
VCC Electrical operating potential

1. A lighting device for mechanical connection to a textile, in particular a garment, comprising
at least one electrically operable illuminant which emits light upon an electrical operating voltage being applied to it,
at least one light guiding element which, in terms of lighting engineering, is coupled to the at least one illuminant and is configured at least partly to receive, to guide and to emit the light emitted by the at least one illuminant,
an at least three-pole electrical luminaire plug connector for electrical connection to an electrical battery appliance, which provides the electrical operating voltage, wherein the luminaire plug connector is electrically connected to the at least one illuminant in order to apply the electrical operating voltage of the battery appliance to the illuminant,
wherein the at least one illuminant and/or the at least one light guiding element have/has at least one connection element for mechanical connection to the textile,
characterized by
a control voltage unit, which is electrically coupled to the luminaire plug connector for application of the electrical operating voltage and is configured to provide depending on the at least one illuminant at the luminaire plug connector a control voltage for control of the operating voltage by means of the battery appliance.

2. The lighting device as claimed in claim 1, characterized in that the luminaire plug connector is configured in accordance with a USB standard.

3. The lighting device as claimed in claim 1, characterized in that for providing the control voltage the control voltage unit has at least one electrical resistor (R1, R2) which is electrically connected by one of its terminals to one of two electrical potentials (VCC, GND) of the electrical operating voltage.

4. The lighting device as claimed in claim 1, characterized in that for providing the control voltage the control voltage unit comprises at least one computer unit.

5. The lighting device as claimed in claim 1, characterized in that the control voltage unit has an energy storage cell for storing electrical energy.

6. The lighting device as claimed in claim 1, characterized by an overvoltage protection unit.

7. A battery appliance for a lighting device as claimed in claim 1, comprising
at least one battery cell for reversible electrochemical storage of electrical energy,
an energy converter connected to the at least one battery cell and serving for providing an operating voltage, and
an at least three-pole electrical battery plug connector for electrical connection to the lighting device, wherein for providing the operating voltage for the lighting device the battery plug connector is electrically connected to the energy converter,
characterized by
a setting unit electrically coupled to the energy converter and the battery plug connector and serving for controlling the energy converter, wherein the setting unit is configured to set the operating voltage depending on a control voltage of the lighting device detected at the battery plug connector.

8. The battery appliance as claimed in claim 7, characterized in that the battery plug connector is configured in accordance with a USB standard.

9. The battery appliance as claimed in claim 7, characterized in that the setting unit comprises a regulator unit for regulating the operating voltage depending on the control voltage.

10. The battery appliance as claimed in claim 7, characterized in that the setting unit is configured to detect a state of charge of the at least one battery cell and to set the operating voltage depending on the detected state of charge.

11. The battery appliance as claimed in claim 7, characterized by at least one connection element for releasable mechanical connection to a textile.

12. The battery appliance as claimed in claim 7, characterized by an at least partly flexibly configured housing.

13. A lighting system for mechanical connection to a textile, in particular a garment, comprising
a lighting device for mechanical connection to the textile and comprising at least one electrically operable illuminant which emits light upon an electrical operating voltage being applied to it, at least one light guiding element which, in terms of lighting engineering, is coupled to the at least one illuminant and is configured at least partly to receive, to guide and to emit the light emitted by the at least one illuminant, an at least three-pole electrical luminaire plug connector for electrical connection to an electrical battery appliance, which provides the electrical operating voltage, wherein the luminaire plug connector is electrically connected to the at least one illuminant in order to apply the electrical operating voltage of the battery appliance to the illuminant, and wherein the at least one illuminant and/or the at least one light guiding element have/has at least one connection element for mechanical connection to the textile, and comprising
the battery appliance for the lighting device, wherein the battery appliance comprises at least one battery cell for reversible electrochemical storage of electrical energy, an energy converter connected to the at least one battery cell and serving for providing the operating voltage, and an at least three-pole electrical battery plug connector for electrical connection to the lighting device, wherein for providing the operating voltage for the lighting device the battery plug connector is electrically connected to the energy converter,
characterized in that
the lighting device is configured as claimed in claim 1,
the battery appliance further comprises a setting unit electrically coupled to the energy converter and the battery plug connector and serving for controlling the energy converter, wherein the setting unit is configured to set the operating voltage depending on a control voltage of the lighting device detected at the battery plug connector, and
the battery plug connector is releasably connectable to the luminaire plug connector.

14. A textile, in particular a garment,
characterized by
a lighting system as claimed in claim 13.

15. The textile as claimed in claim 14, characterized in that the battery appliance and/or the textile comprise(s) a connection element for releasable connection of the battery appliance to the textile.
